(19) United States
(12) Patent Application Publication
(10) Pub. No.: US 2011/0219627 A1
(43) Pub. Date: Sep. 15, 2011

(54) Nutcracker

(76) Inventor: Norman C. Erickson, Rochester, MN (US)

(21) Appl. No.: 12/723,503

(22) Filed: Mar. 12, 2010

(51) Int. Cl. A47J 43/26

(52) U.S. Cl. 30/120.4

(57) ABSTRACT

A nutcracker having a reciprocating hammer whose movement follows a rotating cam. An adjustable cracking space dimension is determined by the adjustment of an anvil. When the cam rotates so that the low dwell region is in contact with a cam follower of the hammer, the hammer withdraws from a cracking space between the hammer and anvil; during this period, nuts/seeds fall from a hopper into the cracking space. As the cam rotates to the high dwell region, the hammer oscillates into the cracking space which then forces the nuts/seeds against the anvil and cracks them. As the cam continues to rotate again to the low dwell region, the cracked nuts/seeds and shells are dispensed from the cracking space and more nuts/seeds fall into the cracking space from a hopper. The cams are replaceable to accommodate different sizes of nuts, different cracking times, etc. The anvil can also be adjusted to change the width of the cracking space.

### FIELD

This invention relates to commercial nutcrackers, and more particularly relates to a nutcracker having a hammer oscillating into and out of a cracking space having nuts/seeds squeezed and cracked between the reciprocating hammer and anvil. The hammer oscillates only a small distance as determined replaceable cams.

### BACKGROUND

There are many kinds of nutcrackers but so far none have been made for the small commercial farmer to crack nuts/seeds of many sizes.

### SUMMARY OF THE INVENTION

Thus what is disclosed herein is a nutcracker that is efficient, reliable, low-cost, easy-to-fabricate, simple-to-operate, portable, scalable and easily adaptable to a wide variety of nut sizes and shapes.

Disclosed herein is a nutcracker, comprising a housing comprising at least a bottom plate having a void therein; an adjustable anvil mounted in the housing having an anvil cracking face proximate to a cracking space; a hammer mounted in the housing having a hammer cracking face opposite the cracking space from the anvil cracking face and positioned so that the anvil cracking face and the hammer cracking face are parallel; a removable rotating cam having a low dwell region and a high dwell region mounted in the housing; and a cam follower attached on an end of the hammer opposite the hammer cracking face to be in rotational contact with the rotating cam, whereby when the low dwell region of the cam is in rotational contact with the cam follower, the hammer is retracted from the cracking space and when the high dwell region of the cam is in rotational contact with the cam follower, the hammer is moved into the cracking space and the nuts/seeds are cracked and dispensed through the void in the bottom plate.

The housing may have a bottom plate having a void therein, a top plate having a void therein, a front plate, a back plate, an anvil-side end plate, and a hammer-side end plate. A hopper can be attached to the nutcracker wherein the hopper slopes from the void in the top plate to the cracking space. Hopper may have guide plate attached to an upper surface of the anvil and a second guide plate movably attached to an upper surface of the reciprocating hammer. The hopper flexibly attached to the hammer and anvil so that nuts/seeds to be cracked are guided and joggled into the cracking space by the anvil hopper guide plate and the hammer hopper guide plate. There may be one or more more anvil guide bearings and one or more hammer guide bearings to restrict motion of the anvil and hammer, respectively, within the nutcracker. The position of the anvil determines the width of the cracking space and can be adjusted using an anvil positioning rod extending from the anvil towards and through the anvil-side end plate. There may also be one or more hammer return springs whose tension can be adjusted, the hammer return springs connected to the hammer and connectible to the hammer-side end plate to provide a compression force to retract the hammer from the cracking space. A shock-absorbent material may be applied to the cracking surface of the hammer and/or the anvil.

The replaceable rotating cam has a low dwell region and a high dwell region and may be mounted on a rotatable hammer-drive cam shaft extending through the front plate and the back plate. The arc length of the low dwell region may be the same or different than the arc length of the high dwell region, the hammer reciprocating into and out of the cracking space by the depth difference between the low dwell region and the high dwell region of the cam. The rotatable hammer-drive cam shaft may have a keyway on one or more ends the cam shaft for connection to a motor external to the nutcracker to rotate the hammer-drive cam shaft. The rotatable hammer-drive shaft may be mounted onto one or more sealed bearings mounted onto the housing at holes through which the rotatable hammer-drive cam shaft extends through at least one of the front plate and the back plate.

These and other features of the embodiments are best understood when reading the Detailed Description of the Invention in conjunction with viewing the figures of the Drawing as described below.

### BRIEF DESCRIPTION OF THE FIGURES

FIG. 1 is a front view of an embodiment of the nutcracker as described herein wherein the front and top plates are removed.

FIG. 2 is a front view of the anvil-side of the nutcracker in an embodiment as described herein.

FIG. 3 is a front view of the hammer-side of the nutcracker in an embodiment as described herein.

FIG. 4 is a perspective view of an embodiment of the nutcracker as described herein.

FIG. 5A is a a plan view of an embodiment of a cam and hammer-drive cam shaft that can be used in accordance with embodiments of the nutcracker as described herein.

FIG. 5B is a cross-sectional view of an embodiment of a cam and hammer-drive cam shaft.

FIG. 6A is a plan view of the hammer-side of the nutcracker in accordance with an embodiment described herein. FIG. 6B is a cross-section of the cam, the cam shaft, the cam follower, and the hammer in accordance with an embodiment of the nutcracker.

FIGS. 7A, 7B, 7C provide illustrations of the nutcracking cycle as the cam rotates and the hammer reciprocates in response thereto in accordance with an embodiment of the nutcracker as described herein.

### DETAILED DESCRIPTION OF THE INVENTION

The invention is described with reference to the accompanying drawings; however, the invention may be embodied in different forms and should not be construed as limited to the embodiments set forth herein. Rather the illustrated embodiments are provided so that this disclosure is thorough and complete, and fully conveys the scope of the invention to those skilled in the art. Like numbers refer to like elements throughout.

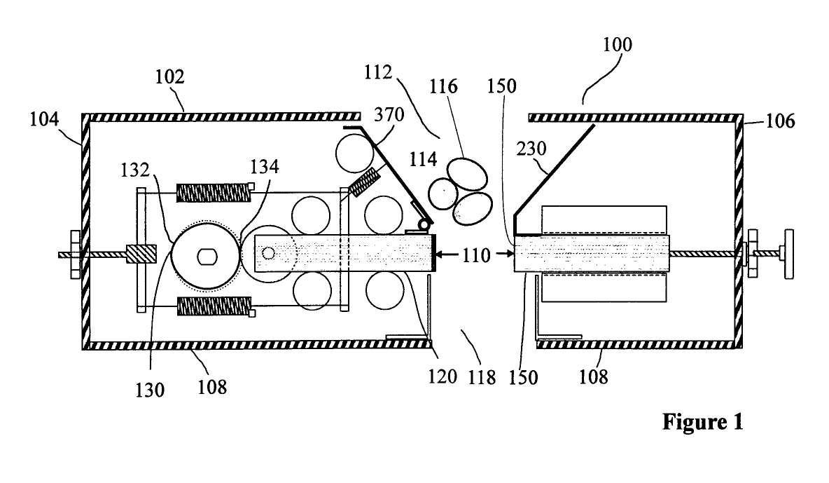

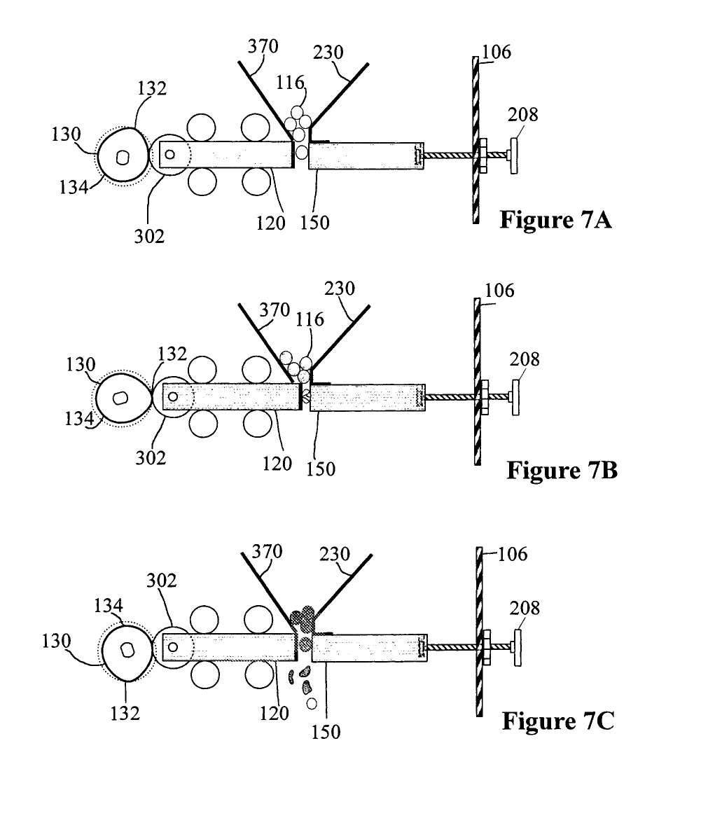

Referring to FIG. 1, shown is a front view of the nutcracker 100 having the front plate removed. Cracking space 110 between the hammer 120 and the anvil 150 can be set to be a range pertaining to the size of the nuts/seeds to be cracked. The nutcracker 100 is intended to be able to crack nuts and seeds ranging in size from sunflower seeds and pinon nuts or smaller to walnuts and larger seeds. Cracking is achieved by the hammer 120 moving back and forth into the cracking space 110 so that nuts/seeds are cracked between the hammer 120 and the anvil 150 150. The hammer 120 follows a rotating cam 130 and during the low dwell 132 of the cam 130, the hammer 120 moves away from the anvil 150. During the rotation time at which the low dwell 134 of the cam 130 is in contact with the cam follower of the hammer 120, nuts/seeds 116 in the hopper 114 fall by gravity into the cracking space 110 between the hammer 120 and the anvil 150; during the time at which the high dwell 132 of the cam 130 is in contact with the cam follower of the hammer 120, the hammer 120 is struck towards the anvil 150 and the shells of the nuts/seeds crack. Then, upon rotation of the cam 130 to the low dwell 134, the hammer 120 retracts from the anvil 150, the cracking space 110 widens, the shells and the kernels or meats of the nuts/seeds 116 fall away from the cracking space 110 and additional nuts/seeds 116 then drop from the hopper into the cracking space 110. This is explained more during the descriptive narrative of FIGS. 7A-7C.

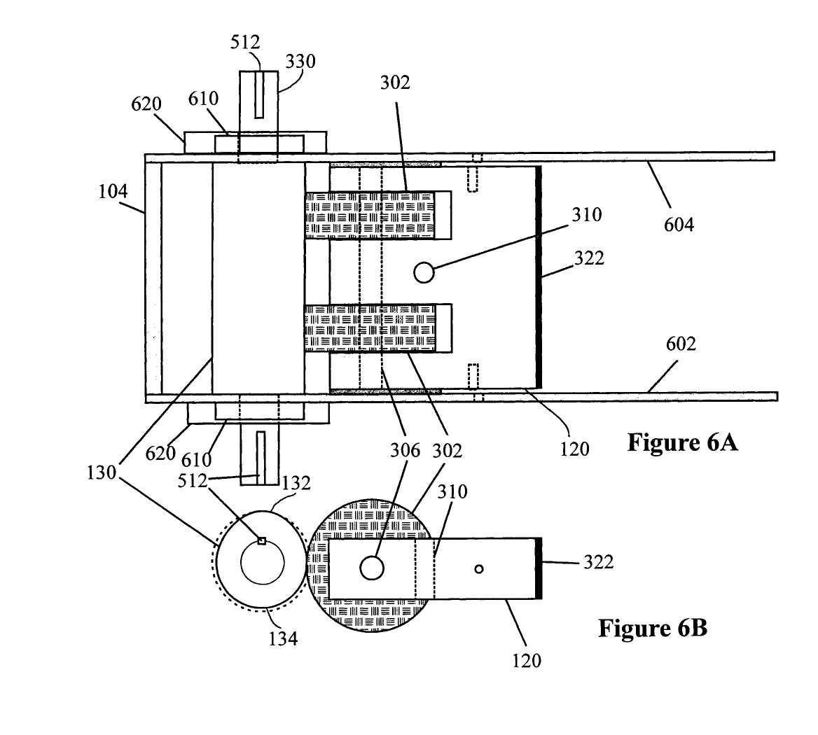

Further with reference to FIG. 1, nutcracker 100 is generally in a rectangular shape, although it need not be, having an interior defined by removable end plates 104, 106, removable front and rear plates (not seen in FIG. 1, shown in FIG. 6), a removable top plate 102. Bottom plate 108 of the nutcracker 100 may or may not be removable and may be made of a heavier gage metal or thicker material than the plates 102, 104, 106 and front and rear plates. Top plate 102 has an opening 112 to a narrowing chuted hopper 114 whereby nuts/seeds 116 are inserted into the nutcracker 100. Suitable material for the plates include steel, aluminum, titanium, reinforced resin, any rigid material that is strong enough to support the components inside and withstand the vibration. Preferably the dimensions and the weight of the plates and inside components of the nutcracker are lightweight for portability as well.

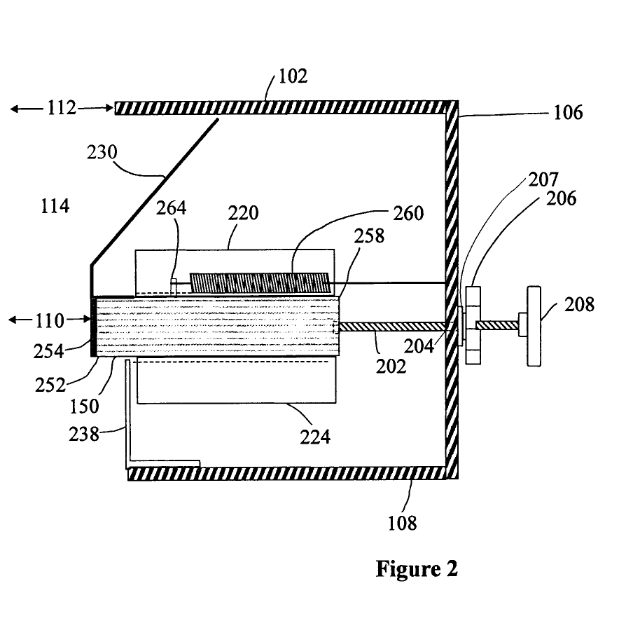

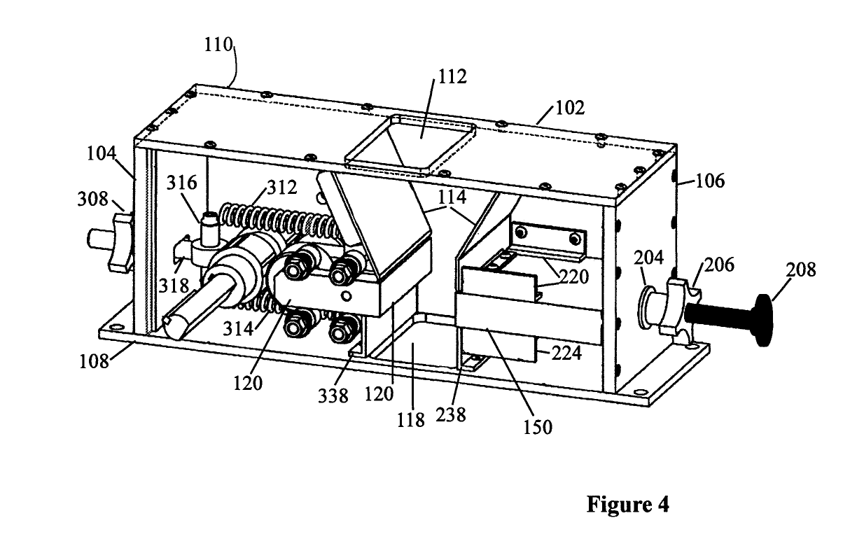

The front view of the anvil-side of the nutcracker 100 is enlarged and shown in FIG. 2. It is also helpful to view FIG. 4 in conjunction therewith. Anvil 150 is mounted within the nutcracker 100 as shown and described herein. An end face 258 of anvil 150 away from the hammer 120 is fixed to an anvil adjusting screw 202. The anvil adjusting screw 202 extends from the interior of the nutcracker 100 through a hole 204, which may be threaded, in the end plate 106 and is attached to an anvil adjusting crank or knob 208. As the anvil adjusting crank 208 is rotated, the anvil 150 and the anvil adjusting screw 202 are moved towards or away from the hammer 120 thereby decreasing or increasing the cracking space 110, respectively. An anvil return spring 260 may be connected to the end plate 106 and to the anvil 150 at a spring connector 264 on the anvil 150 which may enhance performance by providing return tension so that the anvil 150 follows the anvil adjusting screw 202 when the screw 202 is retracted. Once the cracking space 110 is correctly positioned for the size of nuts/seeds to be cracked, the anvil 150 can be locked into place by the anvil adjustment locking knob 206 and a friction washer 207 rotated against the end plate 106. An upper anvil guide 220 and a lower anvil guide 224 restrict the movement of the anvil 150 in a plane parallel to the movement of the hammer 120 to create and maintain the cracking space 110. A resilient material 254 may be coated or otherwise applied to the anvil end face 252 towards the hammer 120. Resilient material 254, such as a urethane or rubber or dense elastic coating, preferably has compression and expansion characteristics to increase the cracking effectiveness of the nutcracker 100 by storing energy as shells are compressed and releasing the energy as cracking commences. Below the anvil 150 and proximate to the cracking space 110 is an anvil dust shield 238 to prevent cracked shells, nuts/seeds and dust from moving into parts of the nutcracker 100. Attached to the upper plane of the anvil 150 at the face towards the cracking space 110 extending upwardly and angled away from the cracking space 110 is the anvil hopper plate 230. Preferably, the anvil hopper plate 130 is manufactured from a durable material to withstand the vibration of the nutcracker 100. Anvil hopper plate 130 is attached and, in one embodiment, is at a fixed angle with respect to the anvil 150 and moves with the anvil 150. In other embodiments, the angle of the anvil hopper plate 130 may be variable and/or may be fixed to the housing of the nutcracker 100.

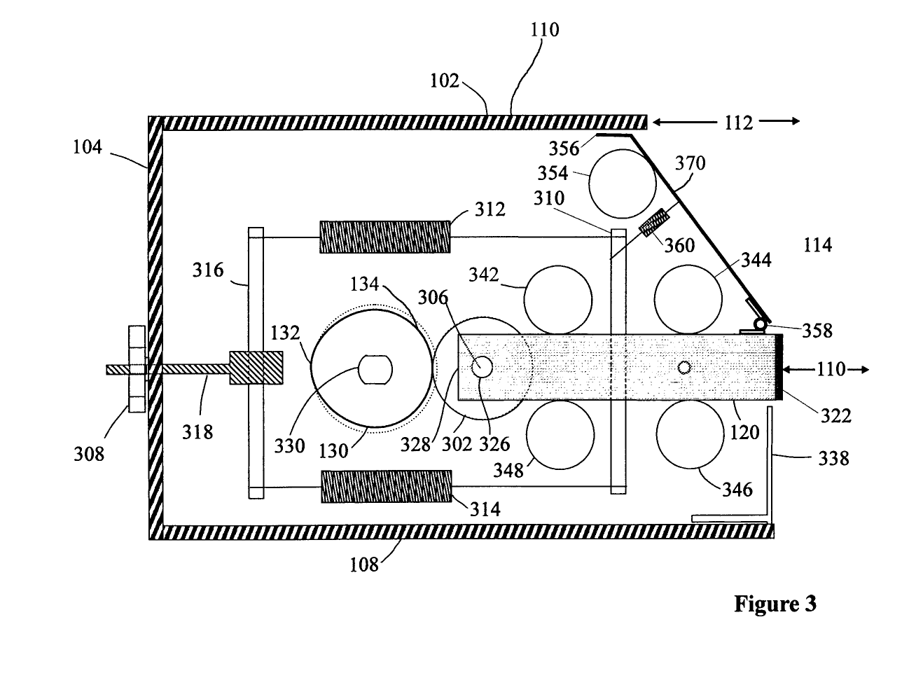

FIG. 3 is an enlarged perspective of the hammer-side of the nutcracker 100; it is also useful to view FIG. 4 together herewith. The hammer 120 is positioned in the nutcracker 100 so that the end face 322 of the hammer 120 moves towards the anvil 150 into the cracking space 110. Resilient material 254, such as urethane, may also be applied to the end face 322 of the hammer 120 towards the cracking space 110. Extending through the hammer 120 away from the anvil 150 is a hole 326 through the depth of the hammer 120 into which a cam follower axle 306 can be inserted and secured. Positioned on the cam follower axle 306 is at least one cam follower 302; there may be a second or more cam followers 302 also mounted on the cam follower axle 306. Cam follower(s) 302 are secured on the axle 306 with a cam follower bearing (not shown) so that the cam follower(s) 302 may rotate freely within in one or more cutouts of the hammer 120, which can be seen more clearly in FIG. 6.

Cam 130 is mounted on a hammer-drive hammer-drive cam shaft 330 that extends into the nutcracker 100 perpendicular to the front end plate (not shown) and parallel to the side plate 104 and the cam follower axle 306. Hammer-drive hammer-drive cam shaft 330 is attached to a motor (not shown in FIG. 3 but described herein) which rotates the cam 130. The cam 130 has a high dwell region 132 and a low dwell region 134. One of skill in the art will appreciate that the depth and the circumferential arc of each dwell region may vary from that illustrated as will be discussed herein; one may also appreciate that there may be more than one high dwell region 132 and/or more than one low dwell region 134. The cam 130 is in contact with the cam follower 302 and as the cam 130 rotates, the cam follower 302 also rotates and causes the hammer 120 to oscillate or reciprocate into and out of cracking space 110, i.e., when the high dwell region 132 of cam 130 is in contact with the cam follower 302, the hammer 120 is pushed towards the anvil 150 in the cracking space 110 and when the low dwell region 134 of the cam 130 is in contact with the cam follower 302, the hammer 120 retracts away from the anvil 150.

Attached to hammer 120 is a rigid hammer return spring attachment rod 310 extending through the height of the hammer 120. Another rigid hammer return spring attachment rod 316 may extend vertically parallel to hammer return spring attachment rod 310. Attached between the rods 310, 316 is a first hammer return spring 312 and a second hammer return spring 314. The hammer return springs 312, 314 are slightly stretched when the high dwell region 132 is in contact with the cam follower 302 which causes the hammer 120 to move into cracking space 110 and when the low dwell region 134 is in contact with the cam follower 302, the hammer return springs 312, 314 pull the hammer 120 away from the anvil 150 towards the direction of the end plate 104. Hammer return springs 312, 314 are attached to a second hammer return spring attachment rod 316 which may further be attached or extend into a hold in a threaded hammer return spring tension adjusting rod 318. Once the proper tension is realized in the hammer return springs 312, 314, i.e., when the hammer 120 returns quickly without jarring or thrusting the cam follower 302 against the cam 130 during rotation, the hammer return spring tension adjusting knob 308 can be tightened against end plate 104 to maintain the tension. The hammer 120 oscillates or reciprocates according to the rotation of the cam 130, as will be further explained, and is guided by at least one, preferably two, upper guide bearings 342, 344 and at least one, preferably two, lower guide bearings 346, 348. Positioned adjacent cracking space 110 and below the hammer 120 is a hammer dust shield 338 to prevent cracked nuts, shells and dust from flying into the moving parts of the nutcracker 100.

Mounted to the top of the hammer 120 towards the cracking space 110 is a hopper plate hinge 358 to which the hammer-side hopper plate 370 is attached. The hammer-side hopper plate 370 may be anchored to the hammer 120 with one plate of the hinge 358 screwed or otherwise attached to the hammer 120 preferably using elongated holes to permit adjustment or alignment of the hammer-side hopper plate 370 with the front of the hammer 120. The hammer-side hopper plate 370 may be screwed or otherwise fixed to the upper portion of the hopper plate hinge 358. The upper end of the hammer-side hopper plate 370 may be be free to pivot or slide on a hopper guide bearing 354 mounted below the top plate 102 to permit free rotation of the hopper guide bearing 354 in the nutcracker 100 which may be similar to the guide bearings 342, 344, 346, 348. Top edge 356 of the hopper plate 370 may be bent an an obtuse angle with respect to the face of the hammer-side hopper plate 370 into the hopper 114 so that the top edge 356 is approximately parallel to the top plate 102 for enhanced rigidity. The hammer-side hopper plate 370 may be attached to a hopper plate spring 360 connected to the spring rod 310 to permit movement and joggling of the hopper plate as the hammer 120 oscillates. The movement and position of the hammer-side hopper plate 370 is responsive to the movement of the cam 130; the lower portion of the hammer-side hopper plate 370 nearer the hopper plate hinge 358 performs a joggling function and the top of the hammer-side hopper plate 370 nearer the hopper plate guide bearing 354 slides up and down and rotates slightly as the hammer 120 oscillates to facilitate downward movement of the nuts/seeds.

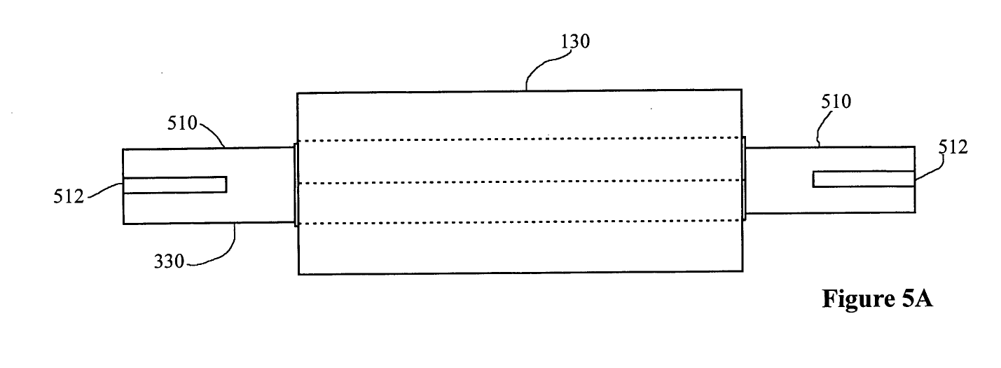

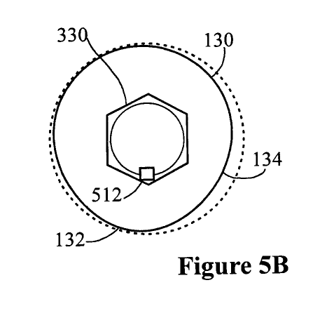

FIG. 5 is an illustration of an embodiment of the cam 130 on the hammer-drive cam shaft 330 removed from the nutcracker 110. Preferably, cam 130 and hammer-drive cam shaft 330 are removable so that different cams 130 can be substituted to accommodate different sizes of nuts, cracking capabilities, etc. The hammer-drive cam shaft 330 is in a generally polygon cross-section, such as a hexagon or pentagon shape to prevent the cam 130 from slipping on the hammer-drive cam shaft 330. The outer portions 510 of the hammer-drive cam shaft 330 may have a circular cross-section and have a keyway 512 for attachment to pulleys (not shown) that can be situated exterior to the front and rear plates 602, 604 (FIG. 6) of the nutcracker 100. The cam 330 is preferably machined from an hardenable alloy rod and is bored and broached to produce an inner polygonal surface to abut tightly with the hammer-drive cam shaft 330 to assure proper and tight coupling and avoid slippage between the cam 130 and the hammer-drive cam shaft 330 during rotation, especially when loaded with reciprocation of the hammer 120. It is intended that cam 130 be replaceable with different cams having different high dwell and low dwell regions. The hammer-drive cam shaft 330 is supported in the nutcracker 100 using at least one sealed bearing, preferably mounted on a face of the nutcracker 100 as is known in the art, the one or more bearings could also be mounted on the interior of the nutcracker 100. Hammer-drive cam shaft 330 may be inserted directly into a motor for rotation or may be inserted into a drive pulley connected by a drive belt to a motor. A typical rotational speed of the hammer-drive cam shaft 330 may be between one-hundred and one-thousand revolutions per minutes; of course, depending upon the motor and the size, density, hardness of the shells of the nuts/seeds to be cracked. At the opposite end of the hammer-drive cam shaft 330 away from the motor or drive pulley, hammer-drive cam shaft 330 may also be attached to a flywheel (not shown) so that the rotational energy can be harvested and stored in a battery, used elsewhere for, e.g., a separator that separates the cracked shells from the meats and/or moves the cracked nuts/seeds away from the nutcracker 100. In some instances, the motor is under load from the cracking operation for less than one-fourth rotation of the hammer-drive cam shaft 330.

As mentioned, nutcracker 100 preferably has removable cams 130 that the user installs based upon the size of the nuts/seeds being cracked. FIG. 5B is cross-sectional view of the cam 130 installed on the hammer-drive cam shaft 330. The dotted line represents a circular cam and is intended to more clearly illustrate the high dwell region 132 and the low dwell regions 134 of the cam 130. The cam 130 that is installed determines the hammer's 120 operating range of motion, i.e., the range of travel of the hammer 120 is determined by the difference in depth between the low dwell region 134 and the high dwell region 132 of the cam 130. The return pressure on the hammer-side return springs, the relative depth of the lower dwell 134 to the upper dwell 132 of the cam 130, and the centrifugal acceleration of the cam 130 are factors in determining the penetration force of the hammer 120 against the nuts/seeds as the hammer 120 moves into the cracking space 110. Ideally, there should be sufficient time and force to crack the shell with minimal damage to the nut meat. Preferably, the anvil 150 is adjusted while the hammer 120 is retracted when the cam follower 302 is in contact with the low dwell 134 of the cam to set the width of the nut cracking space for the size of the nuts/seeds to be cracked. The proper setting and the proper velocity of the cam rotation allows cracked nuts/seeds to fall out of the nut cracking space 110 and replenish the cracking space 110 during the rotational cycle when the low dwell region 134 is in contact with the cam follower 302. When operating with the correct cams 130 and the optimal anvil 150 adjustment virtually all of the nuts/seeds will be cracked in one pass with minimal meat damage. The duration of the effective “open” time for the broken nuts/seeds to drop out and unbroken nuts/seeds to fall into the cracking region between the hammer 120 and anvil 150 is affected by nut size, the depth of the low dwell region 134 of the cam 130 and duration and anvil 150 opening adjustment.

FIG. 6A is a plan view of the hammer-side of the nutcracker with the embodiment of using one cam 130 mounted on the hammer-drive cam shaft 330 extending beyond the front face 602 and the rear face 604 of the nutcracker 100. Note that in this embodiment, the hammer 120 actually is cut out in a fingered arrangement so that two cam followers 302 can be mounted onto the cam follower axle 306. The depth of the low dwell region is the widest differential along the diameter from the outer circumference if the periphery of the cam were a continuous circle. Examples of depths, i.e., the distance that the hammer 120 reciprocates may typically range from ½ inch to 1/16 inch, although it will be appreciated by one of skill in the art that for some nuts, e.g., coconuts, the reciprocation depth may need to be larger. Although, as shown, the high dwell region 132 has a shorter arc length than the low dwell region 134, it need not be so. When these cams are used, the hammer 120 will be retracted for a longer period of time during which the cracking space will be wider. In other cam profiles wherein the low dwell region has the shorter arc length than the high dwell region, the hammer 120 is retracted for a shorter period of time.

This process by which the nuts/seeds are cracked is illustrated in FIGS. 7A-7C. In FIG. 7A, the cam 130 rotates clockwise so that the cam follower 302 rotates in a counter clockwise direction. The cam follower 302 is attached to the axle extending through the hammer 120. In FIG. 7A, the cam 130 in the low dwell position 134 and hammer 120 is retracted from the cracking space 110 as nuts/seeds fall into the cracking space 110. The anvil 150 has been adjusted so that the width of the cracking space is approximately the same diameter or major axis or minor axis of the nut/seed to be cracked. In FIG. 7B, the cam continues its clockwise rotation and the cam follower of the hammer 120 continues to rotate counter clockwise and the cam 130 rotates so that the cam follower is in contact with the high dwell region 132 and the hammer 120 is pushed into the cracking space 110 and the nuts/seeds are cracked. In FIG. 7C, the cam 130 continues its rotation so that the low dwell region 134 is in contact with the cam follower 302, the hammer 120 retracts with the aid of the springs (not shown in FIG. 7), the cracking space 110 widens, cracked nuts/seeds, shells and debris fall out of the nutcracker through a hole in the bottom plate and more nuts/seeds fall into the cracking space. The rotation speed of the cam 130 and the circumference or the arc length of the low dwell region 134 is such that the cracking space is open only long enough for cracked nuts/seeds and shells to fall from the cracking space and for uncracked nuts/seeds to move into the cracking space but not beyond it.

Having thus described several embodiments in detail and by reference to the drawings, it will be apparent that modifications and variations are possible without departing from the scope of the invention defined in the appended claims. For instance, the cam shown in the figures approximates the same depth of the hammer from the front plate to the rear plate, but more than one cam may be used, and the cam(s) may be shorter or longer depending upon the particular nut/seeds to be cracked. Although one cam is illustrated, there may be a separate cam for each cam follower. Similarly, the embodiment shown herein has two cam followers but there may be other embodiments where one cam follower extends nearer to the depth of the hammer from the front plate to the rear plate or there may be more cam followers than the two illustrated. One of skill in the art will appreciate that the nutcracker for seeds need not be of such durable metal as a nutcracker used for nuts having thick shells. The shape of the hopper may vary, while shown here is as having flat surfaces, hopper may just as well be a curved cone descending into the cracking space. The plates preferably have ventilation spaces or voids or holes provided so that compressed air can be used to flush dirt and debris from the interior of the nutcracker. The hammer return springs, shown as being attached to a rod adjacent to an endplate may be attached to the endplate itself; the hammer return springs may be positioned other than above and below the hammer, e.g., hammer return springs may instead be above or below the hammer but towards the front and back plates. There may be fewer or more than two hammer return springs. Thus, the nutcracker is defined by the scope of the claims herein and the equivalent structures.

What is claimed is:

1. A nutcracker, comprising:
a housing comprising at least a bottom plate having a void therein;
a hopper sloping to a cracking space;
an adjustable anvil mounted in the housing having an anvil cracking face proximate to the cracking space;
a hammer mounted in the housing having a hammer cracking face opposite the cracking space from the anvil cracking face and positioned so that the anvil cracking face and the hammer cracking face are parallel;
a removable rotating cam having a low dwell region and a high dwell region mounted in the housing; and
a cam follower attached on an end of the hammer opposite the hammer cracking face to be in rotational contact with the rotating cam;
whereby when the low dwell region of the cam is in rotational contact with the cam follower, the hammer is retracted from the cracking space and when the high dwell region of the cam is in rotational contact with the cam follower, the hammer is moved into the cracking space and the nuts/seeds are cracked and dispensed through the void in the bottom plate.

2. The nutcracker of claim 1, further comprising:
a hammer-side end plate fixed to and extending upward from the bottom plate;
at least one hammer return spring connected to the hammer and connectible to the hammer-side end plate to provide a force to retract the hammer from the cracking space.

3. The nutcracker of claim 1, further comprising:
a hammer return spring connecting rod;
a hammer spring tension adjusting rod
whereby the hammer return spring connecting rod is connected to the hammer return spring and to the hammer spring tension adjusting rod whereby the hammer spring tension adjusting rod moves the hammer spring connecting rod relative to the hammer to adjust the tension in the at least one hammer return spring.

4. The nutcracker of claim 1, further comprising:
an anvil-side end plate fixed to and extending upward from the bottom plate; and
an anvil positioning rod extending from the anvil towards and through the anvil-side end plate whereby the anvil can be moved relative to the anvil-side end plate which in turn changes a width of the cracking space.

5. The nutcracker of claim 1, further comprising:
a shock-absorbent material adherent on the cracking surface of the hammer towards the anvil.

6. The nutcracker of claim 1, further comprising at least one anvil guide bearing mounted in the housing upon which the anvil is positioned.

7. The nutcracker of claim 1, further comprising at least one hammer guide bearing mounted in the housing upon which the hammer is positioned.

8. The nutcracker of claim 1, further comprising:
an anvil hopper guide plate attached to an upper surface of the anvil, nuts/seeds to be cracked guided into the cracking space by the anvil hopper guide plate; and
a hammer hopper guide plate movably attached to an upper surface of the hammer, nuts/seeds to be cracked guided and joggled into the cracking space by the hammer hopper guide plate.

9. The nutcracker of claim 1, further comprising an arc length of the low dwell region of the cam is longer than or the same arc length as the high dwell region of the cam.

10. The nutcracker of claim 1, further comprising an arc length of the high dwell region of the cam is longer than or the same arc length as the low dwell region.

11. The nutcracker of claim 1, further comprising:
a rotatable hammer-drive cam shaft upon which the cam is coupled, the rotatable hammer-drive cam shaft having a keyway on at least one end of the cam shaft for connection to a motor external to the nutcracker to rotate the hammer-drive cam shaft.

12. The nutcracker of claim 1, further comprising:
a rotatable hammer drive cam shaft upon which the cam is coupled, the rotatable hammer-drive cam shaft having a keyway on at least one end of the cam shaft for connection to a flywheel for storing rotational energy as the cam shaft rotates.

13. The nutcracker of claim 1, further comprising:
a plurality of cams mountable in the housing, the depth between the low dwell region and the high dwell region of each of the plurality of cams different than another of the plurality of cams.

14. The nutcracker of claim 1, further comprising:
a plurality of cams mountable in the housing, the arc length of the high dwell region of each of the plurality of cams is different than the arc length of the high dwell region of another of the plurality of cams.

15. A nutcracker, comprising:
a housing comprising a bottom plate having a void therein, a top plate having a void therein, a front plate, a back plate, an anvil-side end plate, and a hammer-side end plate;
a hopper sloping from the void in the top plate to a cracking space, the hopper having an anvil hopper guide plate attached to an upper surface of an adjustable anvil, the hopper further having a hammer hopper guide plate movably attached to an upper surface of a reciprocating hammer, nuts/seeds to be cracked guided and joggled into the cracking space by the anvil hopper guide plate and the hammer hopper guide plate;
the adjustable anvil mounted in the bottom plate, the anvil having an anvil cracking face proximate to the cracking space;
an anvil-side end plate fixed to and extending upward from the bottom plate;
at least one anvil guide bearing mounted in the housing upon which the anvil is slidably positioned;
an anvil positioning rod extending from the anvil towards and through the anvil-side end plate whereby the anvil can be moved relative to the anvil-side end plate which in turn changes a width of the cracking space
the reciprocating hammer mounted in the housing having a hammer cracking face opposite the cracking space from the anvil cracking face and positioned so that the anvil cracking face and the hammer cracking face are parallel and the tops and bottoms of the anvil are on substantially on the same plane as the tops and bottoms of the hammer;
at least one hammer guide bearing mounted in the housing upon which the hammer is slidably positioned;
a hammer-side end plate fixed to and extending upward from the bottom plate;
at least one hammer return spring connected to the hammer and connectible to the hammer-side end plate to provide a compression force to retract the hammer from the cracking space;
a hammer return spring connecting rod;
a hammer spring tension adjusting rod whereby the hammer return spring connecting rod is connected to the hammer return spring and to the hammer spring tension adjusting rod whereby the hammer spring tension adjusting rod moves the hammer spring connecting rod relative to the hammer to adjust the tension in the at least one hammer return spring;
a removable rotating cam having a low dwell region and a high dwell region mounted on a rotatable hammer-drive cam shaft extending through the front plate and the back plate, an arc length of the low dwell region being longer than arc length of the high dwell region, the hammer reciprocating into and out of the cracking space by the depth difference between the low dwell region and the high dwell region of the cam;
the rotatable hammer-drive cam shaft having a keyway on one or more ends the cam shaft for connection to a motor external to the nutcracker to rotate the hammer-drive cam shaft;
at least one cam follower attached on an rotatable axle extending through the hammer opposite the hammer cracking face to permit the at least one cam follower to be in rotational contact with the rotating cam;
whereby when the low dwell region of the cam is in rotational contact with the cam follower, the hammer is retracted from the cracking space and when the high dwell region of the cam is in rotational contact with the cam follower, the hammer is moved into the cracking space and the nuts/seeds are cracked and dispensed through the void in the bottom plate.

16. The nutcracker of claim 15, further comprising:
a shock-absorbent material adherent on the cracking surface of the hammer towards the anvil.

17. The nutcracker of claim 15, further comprising:
one or more sealed bearings mounted onto one or more ends of the rotatable hammer-drive cam shaft on the exterior of the housing at holes through which the rotatable hammer-drive cam shaft extends through at least one of the front plate and the back plate.
